(19) United States
(12) Patent Application Publication
(10) Pub. No.: US 2018/0307221 A1
(43) Pub. Date: Oct. 25, 2018

(54) APPARATUS AND METHOD FOR FAILURE IDENTIFICATION

(71) Applicant: General Electric Company, Schenectady, NY (US)

(72) Inventors: Jason Cline, Roanoke, VA (US); Chris Defalco, Roanoke, VA (US); Sarah Lukens, Roanoke, VA (US)

(21) Appl. No.: 15/496,541

(22) Filed: Apr. 25, 2017

(51) Int. Cl. G05B 23/02; G06Q 10/08; G06Q 10/00

(52) U.S. Cl. CPC G05B 23/0278; G06Q 10/20; G06Q 10/0875; G05B 23/0272

(57) ABSTRACT

Processing data related to the failure of components of industrial machinery is performed. The processing comprises receiving textual information that relates to a repair of an industrial machine, analyzing the textual information to determine a cause of failure or a failure mode for the industrial machine, and then determining additional insights based upon the failure mode.

### BACKGROUND OF THE INVENTION

### Field of the Invention

The subject matter disclosed herein generally relates to failure mode identification in machines and their components and, more specifically, to identifying failures and, in some instances, offering additional insights to users.

### Brief Description of the Related Art

Various types of industrial machines are used to perform various manufacturing operations and tasks. For instance, some machines are used to create and finish parts associated with wind turbines. Other machines are used to create mechanical parts or components utilized by vehicles.

Still other machines are used to produce electrical parts (e.g., resistors, capacitors, and inductors to mention a few examples). In other cases, the machines are not used as part of a manufacturing process, but provide other functions. For instance, the machines themselves may be wind turbines, which convert wind energy into electrical power. Typically, industrial machines are controlled at least in part by computer code (or a computer program) that is executed by a processor that is located at the machine.

The machines often have sensors that measure (or sense) various types of data. For example, temperature, pressure, and speed information may be measured. The sensed information can be used by analytics. Analytics are typically computer programs that operate on the data to provide various results to users. In one example, an analytic may determine the efficiency of a machine or a group of machines. Other analytics can use the data to make predictions of future machine performance.

Various types of problems can occur at machines. This may be observed and recorded by users at the machines. For example, such users may fill out work orders and other types of documents to indicate the type of problems.

During the process of investigating or observing problems (or potential problems) at various machines, a huge amount of information is recorded. Human error often comes into play, for example, when a user mis-codes or otherwise misidentifies a problem. As a result, quality metrics involving the machines are sometimes hard to obtain. This has resulted in some dissatisfaction with previous approaches.

### BRIEF DESCRIPTION OF THE INVENTION

The present invention is directed to determining causes of machine or component failure and taking action. These approaches are easy and cost-effective to implement compared to previous approaches and allow accurate metrics to be obtained concerning machines and machine operation.

Users often code the reasons for machine failure. For example, lists or other data capture approaches are created by users, but these are often not very valuable (e.g., because the customer picks the first choice on a list or does not pay close attention to the contents of the list). However, there may be other textual information, such as long-form notes, created by the user. In other examples, a failure report may identify a manager who has given an approval. The present approaches gather the additional information and process the additional information, for instance, by classifying and/or categorizing the data. The analysis can be used to derive additional insights into the data, such as the type of component that has failed or the person involved. Subsequently, additional insights can be used to identify further functions or actions such as issuing alerts or ordering new parts.

In many of these embodiments, a method for processing data related to the failure of components of industrial machinery is presented. The method comprises receiving textual information that relates to a repair of an industrial machine, analyzing the textual information to determine a cause of failure or a failure mode for the industrial machine, and then determining additional insights based upon the failure mode. The analyzing includes electronically parsing the textual information (e.g., using a computer-based parsing program) for a textual indicator that indicates the cause of failure or the failure mode.

In some examples, the textual information includes a work order, an order for a component, or a replacement approval from a supervisor. Other examples are possible.

In some examples, the additional insight is electronically delivered to the user for the user to take action. In other examples, the additional insight is electronically rendered to the user graphically on an electronic display.

In aspects, the determination of the additional insight includes making an automated determination to take an action. The action can be a variety of actions including ordering a part, issuing an alert, checking an inventory, and/or ordering a repair of the machine. The action can be for a user to accomplish or may be made electronically. Other examples of actions are possible.

In examples, the industrial machine is disposed in or at a factory. In other examples, the industrial machine may be in facilities such as pumping stations, power generation facilities, or any other facility that has machines that perform industrial functions (e.g., boilers and chillers). Other examples are possible.

In still other aspects, the textual information is entered manually. In yet other aspects, the textual information is stored on a computer file at the installation or in the cloud.

In other of these embodiments, a system for parsing large volumes of data relating to the failure of components of industrial machinery is presented. The system has an interface with an input and an output, and the input is configured to receive textual information that relates to a repair of an industrial machine. Further, a control circuit is coupled to the interface, and is configured to analyze the textual information to determine a cause of failure or a failure mode for the industrial machine. Based upon the cause of failure or the failure mode, the control circuit determines additional insights.

### BRIEF DESCRIPTION OF THE DRAWINGS

For a more complete understanding of the disclosure, reference should be made to the following detailed description and accompanying drawings wherein:

FIG. 1 comprises a block diagram of a system for determining a failure or failure mode for a machine or component of a machine according to various embodiments of the present invention;

FIG. 2 comprises a flowchart illustrating an example of an approach for determining a failure or failure mode for a machine or component of a machine according to various embodiments of the present invention;

FIG. 3 comprises a processing apparatus according to various embodiments of the present invention;

FIG. 4 comprises a flowchart of an approach for identifying a source of machine failure or failure mode according to various embodiments of the present invention;

FIG. 5 comprises a flowchart of an example for determining additional insights or actions based upon a failure mode of a machine (or a component of a machine) according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The present approaches are directed to assessing risks associated with the operation of industrial machines based upon textual information received from users. A user can enter the potential reason for a failure at the site of the machine, and this raw textual information is received at a central processing center via a network. The raw data is then parsed (since in many cases the data may be long-form notes) and key features of the textual information are extracted. A trained machine learning algorithm then identifies the source of failure (or the source of a potential failure). In so doing, the operation of the machines (and facilities in which these machines are deployed) is made more efficient, and shutdowns of processes that utilize these machines is minimized, and in some cases, eliminated. Advantageously, determinations can be made automatically (without manual intervention) and in real time.

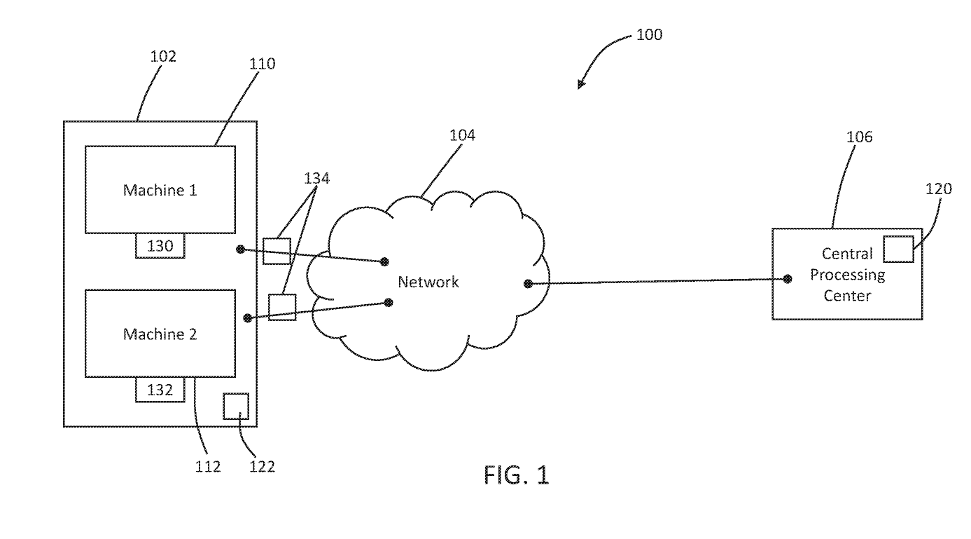

Referring now to FIG. 1, one example of a system 100 that is configured to perform a risk assessment associated with an industrial machine or component of the machine is described. The system includes an installation 102, a network 104, and a central processing center 106.

The installation 102 may be any grouping of one or more industrial machines. In some aspects, the installation 102 may be a factory or other facility including or housing industrial equipment, such as pumping stations or power generation facilities. Other examples of installations are possible.

In the example of FIG. 1, the installation 102 includes a first industrial machine 110 and a second industrial machine 112. Although two machines are shown here, it will be appreciated that any number of machines can be used (e.g., one machine, or more than two machines). The first industrial machine 110 and second industrial machine 112 may be any type of machine or device. In some examples, the first industrial machine 110 and second industrial machine 112 may be a wind turbine, grinder, robot, furnace, computer, controller, or boiler. Other examples of industrial machines are possible.

The machines 110, 112 operate at or within the installation 102. In some aspects, data concerning the operation of the machines 110, 112 is monitored using sensors 130 and 132. For example, various parameters (e.g., temperature, pressure, or speed) are monitored using sensors 130 and 132. Although only two sensors 130 and 132 are shown in the example of FIG. 1, it will be appreciated that any number of sensors may be deployed at the machines 110, 112. In other aspects, and when deviations from expected temperature values occur, the machines 110, 112 send, in examples, time series data obtained by the sensors 130, 132 to the network 104.

The machines 110, 112 may include transceiver circuits that transmit and/or receive information or messages to/from the network 104. In other examples, the machines 110, 112 couple to separate transceiver circuits that are physically separate from the machines 110, 112.

The textual information 134 may be any type of electronic message of information about the machines 110, 112 manually entered by a user at a terminal (e.g., the electronic device 122). The textual message 134 may be according to any format or protocol.

Textual information is entered by users at the electronic device 122 and sent as messages 134 to the network 104. The textual message 134 contain raw textual information entered by a user (e.g., a worker at the installation 102 of FIG. 1) and, in some examples, includes information identifying why the machine failed, such as the temperature of the machine exceeded a predetermined temperature threshold. In other examples, the textual information may be automatically collected and entered into the messages 134. The electronic device 122 be may be any type of device such as a personal computer, laptop, or smartphone. The raw textual information may be in any format such as ASCII.

The network 104 may be any network or combination of networks. In examples, the network 104 may be the cloud, the internet, cellular networks, local or wide area networks, or any combination of these (or other) networks. The network 104 may include various electronic devices (e.g., routers, gateways, and/or processors to mention a few examples).

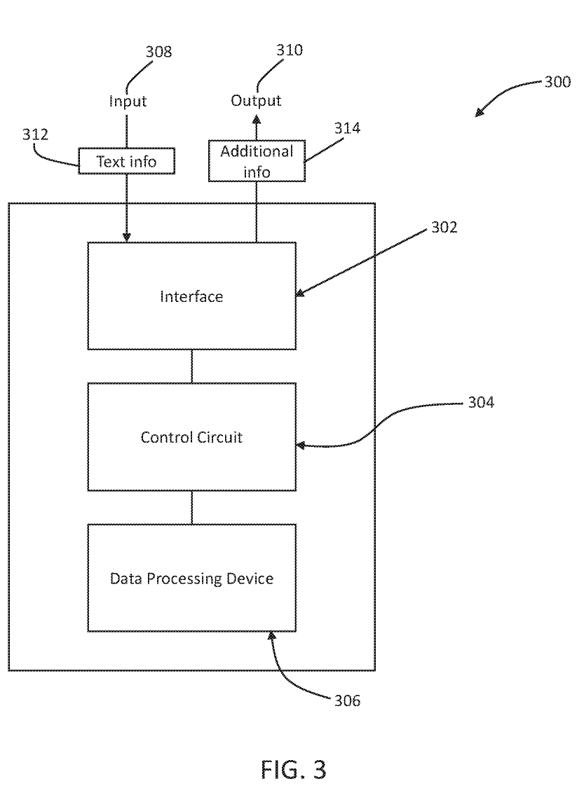

The central processing center 106 may include a processing apparatus 120 (e.g., including a control circuit 304 (see FIG. 3)) that performs various processing functions. The central processing center 106 receives the messages 134 from the electronic device 122 (e.g., personal computers, smart phones, laptops, or tablets), and these messages 134 are processed by the central processing apparatus 120.

In one example of the operation of the system of FIG. 1, analysis of textual information associated with industrial machines 110 or 112 (or components of these machine) is performed by the apparatus 120 at the central processing center 106. The textual message 134 (e.g., long-form reports regarding the machines 110, 112 coded by a user) is received from the electronic device 122 (e.g., in the vicinity of one of the industrial machines 110 or 112) at the central processing center 106 via the network 104.

When the message 134 is received at the apparatus 120, the data is parsed and a trained machine learning algorithm is used to analyze the parsed data to determine a failure mode or cause. In examples, if the algorithm extracts information from the textual message 134 indicating the existence of a work order for a component, an order for a component, and a replacement approval from a supervisor. Based upon this information and in aspects, it is determined that a particular component has failed (or, in other examples, a component may fail in the future).

Various types of additional insights (or actions implementing these insights) may be determined. In one example, the additional insight is to order a part. In another example, the additional insight is to order a repair of the machine. In still another example, additional insight is to issue an electronic alert. An inventory may also be checked. Combinations of these insights may also be determined and presented to users. Additionally, the additional insights may be recommendations for a user to take an action (e.g., have the user order a part) or may be electronic actions (e.g., sending an alert to a user). Other examples of additional insights or actions are possible.

Once determined, the additional insights may be electronically rendered to a user, for example on the electronic device 122 (or other similar electronic devices located in the vicinity of the machines 110, 112, at the central processing center, or at some other location). The rendering electronically presents the insight in a format that can be easily viewed and analyzed by the user. For example, an alert may be presented as a flashing symbol with an audible sound or noise to alert the user. Recommendations to order parts may suggest potential suppliers and present cost comparisons between suppliers. A graphical representation of the machine 110 or 112 may be shown and include the highlighted location of the part. Other examples are possible.

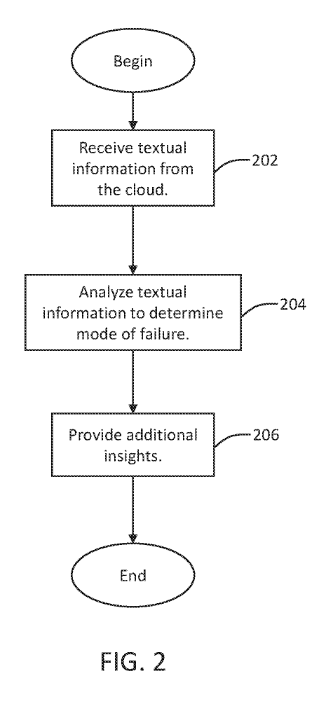

Referring now to FIG. 2, one example of an approach for processing data related to the repair of industrial machinery is described. In this example, a machine couples to a network, and the network is coupled to a central processing center.

At step 202, textual information that relates to a repair of the industrial machine 110, 112 is sent from the network and received at the central processing center. For example, the textual information may be a work order to fix or replace a machine component. In another example, an approval from a supervisor may be reported in a textual message. The textual information may be in the same or different electronic files or documents and may be in any appropriate format (e.g., ASCII).

At step 204, the textual information is analyzed in order to determine a cause of failure or a failure mode for the industrial machines 110, 112. The analysis includes parsing the raw textual data and determining the nature of the data. For example, the information is parsed in order to determine a part or component name or number (e.g., by comparing the information parsed to a list of known part or component names or numbers). The context of the information may also be determined. For example, it may be determined why the information was entered (e.g., as part of a work order or parts order). By analyzing all of this information a cause for failure (or failure mode) may be determined. The cause of failure may identify a part (or component), a reason for failure (e.g., the component is out of service), or additional information regarding a failure.

At step 206, additional insights are provided based upon the analysis performed at step 204, including issuing an alert, ordering a repair part, ordering new parts, or scheduling a repair time. The additional insights may identify additional actions to take. The nature of the actions may depend, in examples, upon the severity of the failure. For example, severe failures may require more immediate actions than less critical failures.

Referring now to FIG. 3, one example of an apparatus 300 that is configured to receive textual information from a network (e.g., the network 104 of FIG. 1) is described. The apparatus 300 includes an interface 302, a control circuit 304, and a data storage device 306.

The interface 302 has an input 308 configured to receive a textual message 312 from the industrial machine. The interface 302 also has an output 310 configured to send information (e.g., messages) related to additional insights to users.

The control circuit 304 may contain a processor for processing data associated with the textual information. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 304 may be configured (for example, by using corresponding programming stored in a memory as will be well understood by those skilled in the art) to carry out one or more of the steps, actions, and/or functions described herein. The data storage device 306 can be any type of memory.

The control circuit 304 is configured to parse large volumes of data relating to the failure of components of industrial machinery. More specifically, the control circuit 304 is configured to analyze the textual information 312 received from users to determine a cause of failure or a failure mode for the industrial machines and, based upon the cause of failure or the failure mode, determine the additional insight 314.

In aspects, the control circuit 304 utilizes any appropriate parsing and/or machine learning algorithm to parse the raw textual data received from users and then determine a cause of failure (or failure mode). Based upon the nature of the failure, the control circuit 304 determines one or more additional insights. The additional insight 314 is then sent at the output 310 to be received by users. Additional insights may include sending an alert to a user to have the component repaired or replaced. Other examples are possible.

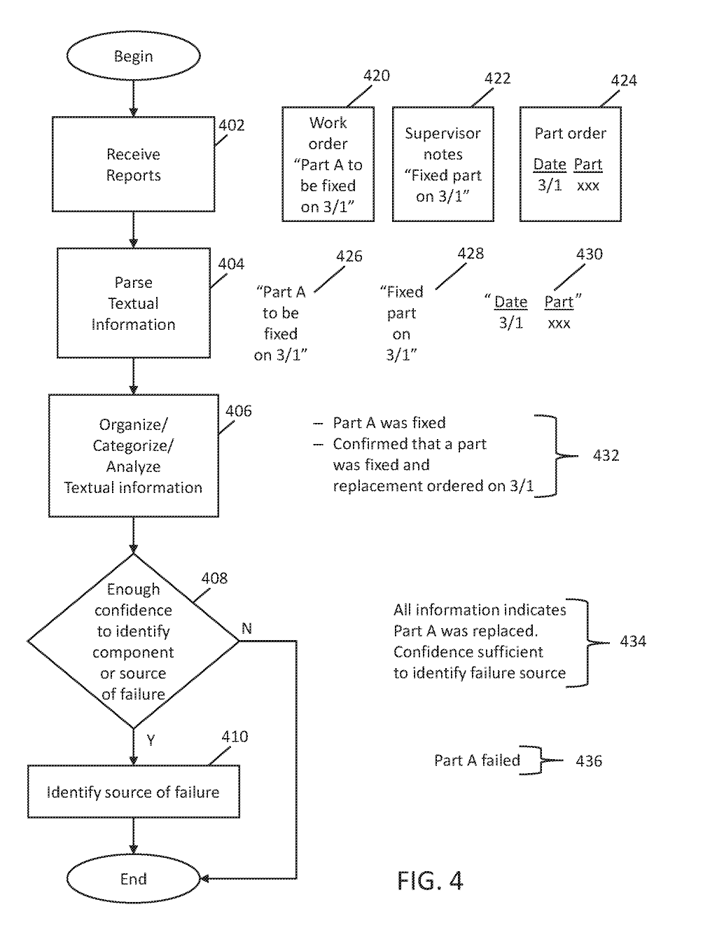

Referring now to FIG. 4, one example of an approach for determining a failure source or mode is described. FIG. 4 is one example of an approach to determine from user-generated textual information a potential failed component or failure mode. It will be appreciated that other examples of approaches are possible. The approach of FIG. 4 may be implemented at a central processing center (e., the apparatus 120 of the central processing center 106 of FIG. 1) as computer instructions executed by a control circuit (e.g., the control circuit 304 of FIG. 3).

At step 402, failure reports and other failure information (entered at machines in an installation) are received at a central processing center. For example, these reports may include a work order 420, supervisor notes 422, and a parts order 424. These may be in any type of file or document format, such as pdf, Word, and Excel. The text itself may be in any format such as ASCII. Other examples are possible.

In examples, the work order 420 may include textual information that a particular part is to be fixed on a particular date: “Part A to be fixed on 3/1”. Additionally, the supervisor notes 422 may include textual information that the part was fixed: “Fixed Part A in 3/1”. Further, the part order 424 may indicate that the part was ordered on a particular date: “Date 3/1, Part XXX”. In other examples, the reports may be more long-form and contain additional information.

At step 404, the textual information from the reports is parsed. By “parsing,” it is meant as the analysis of a string of symbols either in natural language (i.e., text) or computer language (i.e., binary code), and breaking down the symbols into more manageable pieces to extract the most important information. The parsing may be performed by any appropriate parsing program or approach known to those skilled in the art.

In this example, the parsed information includes first parsed information 426 (from work order 420), second parsed information 428 (from supervisor notes 422), and third parsed information 430 (from part order 424). The work order 420, supervisor notes 422, part order 424, and/or any other received report may be long-form, such that a user has input extensive textual information. The parsing of the textual information obtains key information that will later be used by a machine learning algorithm to confidently identify a source of failure. As known to those skilled in the art, any type of conventional document parser can be used.

In the present example, the first parsed information 426 is a key feature of the report: “Part A to be fixed on 3/1.” Similarly, the second parsed information 428 is “Fixed part on 3/1”. Finally, the third parsed information 430 is “Date 3/1, Part XXX”.

At step 406, the parsed information can be organized, categorized, or analyzed by any appropriate machine learning algorithm as known to those skilled in the art. In the present example, the information obtained at step 404 indicates that Part A was fixed and a replacement part was ordered. There is nothing in the information to contradict this information (or lead to a different conclusion).

As mentioned, a machine learning algorithm may be used to analyze the parsed textual information. By “machine learning algorithm” it is meant a process whereby data sets are used to train an algorithm, and the algorithm improves based on new data sets without explicitly being programmed. New information pertaining to the failure or modes of failure of a machine is constantly being gathered. Over time, the algorithm learns more and more about the sources of failure and learns the behavior of the machine. The algorithm constantly refines itself by using past behavior patterns to better anticipate future machine failures. For example, the machine learning algorithm may see that a part consistently fails after 3 months, and it learns to send an alert at 2 months to replace or repair the part before it fails. Other examples are possible.

In this case, preliminary conclusions 432 are formed that indicate the failed part. A confidence level (e.g., an integer) may also be assigned to reflect the confidence of the preliminary conclusion. In aspects, if all information indicates a conclusion is correct (e.g., there is no information that would contradict the conclusion), then a high confidence level is assigned. On the other hand, when only one piece of information indicates a particular conclusion and other pieces of information are not conclusive, a low confidence level may be assigned to the conclusion. It will be appreciated that the exact level of confidence assigned by a particular approach will vary depending upon, for instance, the type of information involved.

At step 408, it is determined whether there is enough confidence to identify the part or source of failure. In one example, result 434 of the analysis indicates Part A was replaced. As mentioned, a numeric confidence level may be determined at step 406. This may be compared to a threshold value. If the answer at step 408 is negative (i.e., insufficient certainty for determining a source of failure), execution ends. If the answer at step 408 is affirmative, then at step 410 a final conclusion 436 is made or determined. In this case, the final conclusion 436 is that Part A failed.

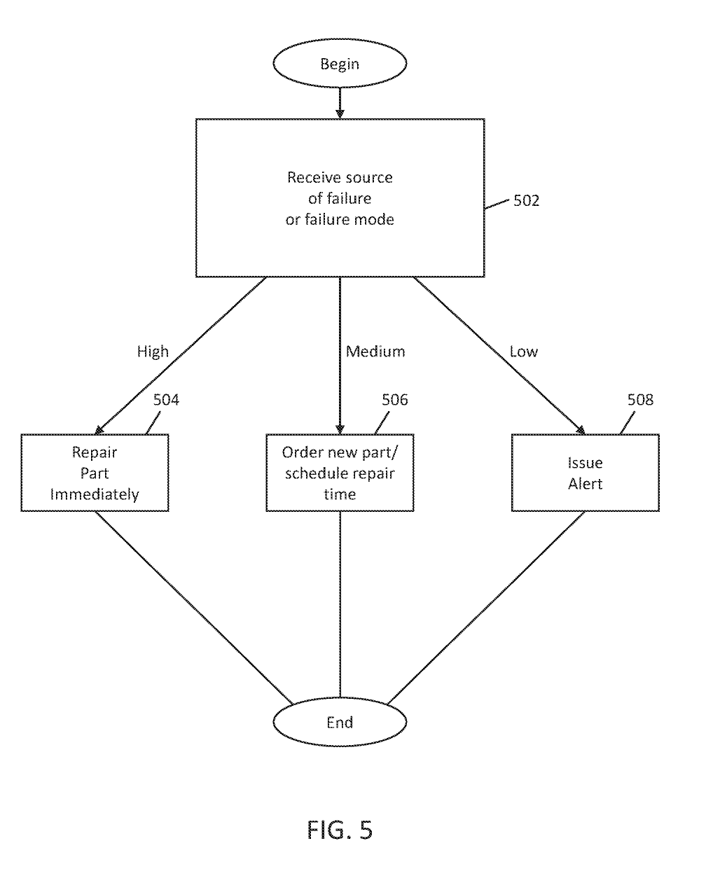

Referring now to FIG. 5, one example of identifying an additional insight (or determining additional actions) is described. It will be appreciated that this is one example of an approach to determine actions, and that other approaches are possible. The approach of FIG. 5 may be implemented at a central processing center (e., the apparatus 120 of the central processing center 106 of FIG. 1) as computer instructions executed by a control circuit (e.g., the control circuit 304 of FIG. 3). It will be understood that the example of FIG. 5 examines the criticality of a failed (or soon to fail) part and maps the level of criticality to an additional insight or action. Other examples are possible.

At step 502, the failure source or mode is received (step 410 of FIG. 4). The next step executed (i.e., identifying the additional insight determined or additional action that is to be taken) depends on the criticality or importance of the failure source or mode (e.g., high, low, or medium in this example). Criticality ratings may, in examples, be integer or real numbers. For example, a machine may have a certain number of parts, and the parts may be ranked in a list according to how critical that part is for the machine to function smoothly, with Part A being the most important and designated as “high” criticality. Part B may be categorized as “medium” criticality, and a Part C may be assigned a “low” criticality designation.

The criticality assigned to a part or component may involve a variety of factors. For example, the relationship of the part to other parts in the machine, the cost of the part, or whether the part has any backup part may be considered. A look-up table may map parts to criticality levels. Once the part that has failed is identified, this table may be accessed to determine the criticality level.

At step 504 and when the part that has failed is identified as being highly critical, a “Repair Part Immediately” message is issued. This message may be received by an operator at the central processing center or by a user at the installation. In aspects, the identified part should be repaired (or replaced) as soon as possible to prevent the machine from completely failing or (if the machine has already failed) bring the machine back on-line as soon as possible.

If the part is of medium criticality (for example, Part B, mentioned above) then step 506 is executed. At step 506, a message to order a new part or to schedule a repair of the part is transmitted. The nature of this insight/action reflects that there may be adequate time to order the part since the part is of a medium level of criticality.

Finally, if the part is of low criticality (for example, Part C, mentioned above) then step 508 is executed. At step 508, an alert is issued to an operator or a user that Part C has failed. The nature of this insights reflects that the part or component is of low criticality and that other actions may need to take place sooner.

For any of the steps 504, 506, and 508, delivery of the insight to a user may be made in any type of electronic message or communication. The message or communication may include graphics that present the insight in a format that can be easily viewed and analyzed by the user at an electronic display device.

After the completion of steps 504, 506 and 508, execution then ends.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method for processing data related to the failure of components of industrial machinery, the method comprising:
receiving textual information that relates to a repair of an industrial machine;
analyzing the textual information to determine a cause of failure or a failure mode for the industrial machine, the analyzing including electronically parsing the textual information for a textual indicator that indicates the cause of failure or the failure mode; and
determining an additional insight based upon the failure mode.

2. The method of claim 1, wherein the textual information includes a work order, an order for a component, or a replacement approval from a supervisor.

3. The method of claim 1, wherein the additional insight is electronically delivered to the user and includes a request or recommendation for the user to take an action.

4. The method of claim 1, wherein the additional insight is electronically rendered to the user graphically on an electronic display.

5. The method of claim 1 wherein determining the additional insight comprises making an automated determination to take an action.

6. The method of claim 5, wherein the action is one or more of ordering a part, issuing an alert, checking an inventory, or ordering a repair of the machine.

7. The method of claim 1, wherein the industrial machine is in a factory.

8. The method of claim 1, wherein the textual information is entered manually.

9. The method of claim 1, wherein the textual information is stored on a computer file or in the cloud.

10. An apparatus that is configured to parse large volumes of data relating to the failure of components of industrial machinery, the apparatus comprising:
an interface with an input and an output, the input being configured to receive textual information that relates to a repair of an industrial machine;
a control circuit, the control circuit coupled to the interface, the control circuit configured to analyze the textual information to determine a cause of failure or a failure mode for the industrial machine, and based upon the cause of failure or the failure mode, determine an additional insight based upon the failure mode.

11. The apparatus of claim 10, wherein the input being configured to receive textual information includes a work order, an order for a component, or a replacement approval from a supervisor.

12. The apparatus of claim 10, wherein the control circuit has a processor and a memory.

13. The apparatus of claim 10 wherein the control circuit is configured to make an automated determination to take an action.

14. The apparatus of claim 13, wherein the action is one or more of: ordering a part, issuing an alert, checking an inventory, or ordering a repair of the machine.

15. The apparatus of claim 10, wherein the input is configured to receive textual information that is entered manually.

16. The apparatus of claim 10, wherein the apparatus is coupled to a network.

17. The apparatus of claim 10, wherein the textual information is stored in the cloud.

18. The apparatus of claim 10, wherein the additional insight is electronically rendered to the user graphically on an electronic display.
